(19) United States
(12) Patent Application Publication
(10) Pub. No.: US 2026/0308063 A1
(43) Pub. Date: Oct. 8, 2026

(54) COMPOSITION AND TREATMENT METHOD THEREOF FOR 3D PRINGTING MATERIAL

(71) Applicant: Nano and Advanced Materials Institute Limited, Hong Kong (CN)

(72) Inventors: Xianrui CHEN, Hong Kong (CN); Xuan Liu, Hong Kong (CN); Chi Kwan Adye Kwok, Hong Kong (CN)

(21) Appl. No.: 19/098,437

(22) Filed: Apr. 2, 2025

(51) Int. Cl. C04B 28/04; B33Y 70/10; C04B 14/06; C04B 18/08; C04B 18/14; C04B 20/02; C04B 22/00; C04B 103/00; C04B 103/20; C04B 103/32; C04B 103/44

(52) U.S. Cl. CPC C04B 28/04; B33Y 70/10; C04B 14/06; C04B 18/08; C04B 18/141; C04B 18/146; C04B 20/023; C04B 22/008; C04B 2103/0053; C04B 2103/0085; C04B 2103/20; C04B 2103/32; C04B 2103/44

(57) ABSTRACT

A formulation for 3D printing concrete utilizing recycled aggregates, comprising over 30% of recycled aggregates of total aggregates, in conjunction with a treatment method. The present invention provides a composition for 3D printing material including a cementitious binder material, aggregates, water and an admixture material. Especially, the aggregates at least include recycled aggregates and silica sand, and the recycled aggregates are treated by a water-soluble polymer. The water-soluble polymer is polyvinyl alcohol (PVA) solution.

### FIELD OF THE INVENTION

The present invention relates to a composition and a treatment method of the composition for 3D printing material. More particularly, the present invention relates to a composition using recycled aggregates and a surface treatment method of the recycled aggregates for 3D printing material.

### BACKGROUND OF THE INVENTION

3D printing technology has been widely used in urban development and construction. With the development of construction technology, especially unmanned construction technology, 3D printing technology has been widely used in the construction industry. 3D printing technology, i.e. 3D construction printing, refers to the automated process of manufacturing construction elements or entire structures by means of a 3D printer. Instead of using ink, 3D printing materials for construction are printed layer-upon-layer, which is also why 3D construction printing goes by the name additive manufacturing or additive construction. Concrete with different shapes and structures is printed out through specific computer-controlled programs. The whole process of computer programming and mechanized construction has realized the reasonable unity of architecture, structure and construction. Moreover, 3D printing construction technology can be carried out both onsite and offsite.

In construction industry works, the amount of concrete used is the largest, even used in the 3D printing materials for construction. The exploitation of natural sandstone resources brought by the application of concrete in urban development and construction causes damage to mountain vegetation and damage to river channels. The waste concrete is used as recycled aggregate to be developed, so that the problems that a large amount of waste concrete is difficult to treat and the ecological environment is gradually deteriorated due to the difficulty are solved. However, the recycled aggregate has a rough surface and a large porosity compared to natural aggregate such as silica sand.

Untreated recycled aggregates may result in higher water absorption, affecting printability such as buildability, extrudability and pumpability, resulting in reduced mechanical strength and high dry shrinkage. The low mechanical performance will result in potential damage during the transportation and service period, and the high dry shrinkage of 3D printed concrete may cause cracks during the hydration or low outdoor temperatures. In particular, when printing prototypes with spans over 1 meter, it has a high chance of deformation or larger cracks due to the relatively low flexural strength. Therefore, it's necessary to include rebar to reinforce the structure, while this may cause more cracks due to the mismatched shrinkage leading to stress concentration between the 3D printed concrete and reinforcement.

### SUMMARY OF THE PRESENT INVENTION

To address these challenges, the present invention proposes a method for surface treating the recycled aggregates to improve the quality consistency and reduce aggregate water absorption, in addition, the aggregate size was also optimized. Therefore, the printability of the developed formulation incorporates 30% recycled aggregates enhanced. This formulation exhibits desirable properties such as improved mechanical performance, reduced shrinkage, lower water absorption and good fire resistance performance. Furthermore, based on the optimized formulation, the prevent invention has successfully been printed and implemented various prototypes, such as planters (1.5 m in length) and long benches (2 m in length), which are currently under service.

The present invention provides a formulation for 3D printing concrete utilizing recycled aggregates, comprising over 30% of recycled aggregates that replace the natural aggregate, in conjunction with a treatment method. The present invention provides a composition for 3D printing material including a cementitious binder material, aggregates, water and an admixture material. Especially, the aggregates at least include recycled aggregates and silica sand, and the recycled aggregates are treated by a water-soluble polymer. The water-soluble polymer is polyvinyl alcohol (PVA) solution. For example, the weight percent concentration of the PVA solution is 5 wt %-15 wt %.

Preferably, the water is in a total weight percentage of the composition from 10% to 20%. The cementitious binding material is in a total weight percentage of the composition from 20% to 40% and comprising 50% to 70% Portland cement. The recycled aggregates are in the total weight percentage from 10% to 30%, and the weight of the recycled aggregates is over 30% of the total aggregates. The silica sand is in the total weight percentage from 25% to 40%.

Preferably, the particle size of each of the recycled aggregates is from 0.3 mm to 2.36 mm. The particle size of each of the silica sand is from 0.3 mm to 0.6 mm.

In an embodiment, the cementitious binding material further includes fly ash, silica fume and/or GGBS (Ground Granulated Blast-furnace Slag).

In an embodiment, the admixture material further includes superplasticizer, thixotropic agent, viscosity modifying agent, retarder and/or expansive additive. In an embodiment, the expansive additive is low dosage expansive additive such as HPCSA (Denka-powder CSA).

The present invention provides a treatment method of a composition for 3D printing material, the steps of the method comprises: (a) providing 5 wt %-15 wt % polyvinyl alcohol (PVA) solution; (b) mixing recycled aggregates into the 5 wt %-15 wt % PVA solution and the mixture of the recycled aggregates soaked at least one day; (c) air drying the mixture of the recycled aggregates for at least 7 days to form a treated recycled aggregates; and (d) mixing the treated recycled aggregates with a cementitious binder material, aggregates, water and an admixture material to form the composition for 3D printing material.

Preferably, the 5 wt %-15 wt % PVA solution is formed by PVA powder mixed with water in temperature from 90° C. to 100° C. The mixture of the recycled aggregates are air dried and spread in a 20° C. environment.

Preferably, the particle size of each of the recycled aggregates is from 0.3 mm to 2.36 mm. The weight of the recycled aggregates is over 30% of total of the aggregates and the recycled aggregates.

### BRIEF DESCRIPTION OF THE DRAWINGS

FIG. 1 is a bar diagram showing the results of compressive strength test of three 3D printed concretes in three directions and their corresponding pouring specimens.

FIG. 2 is a bar diagram showing the results of flexural strength test of three 3D printed concretes in two directions and their corresponding pouring specimens.

FIG. 3 is a bar diagram showing the results of water absorption test, which was followed ASTM C642, of three 3D printed concretes.

FIG. 4 is a line chart showing the results of shrinkage test of three 3D printed concretes.

FIG. 5 is a bar diagram showing the results of tensile strength test after 28 days binding of three 3D printed concretes.

FIGS. 6A to 6D is a process of the treatment effect with PVA solution of a composition for 3D printing material according to the present invention.

FIG. 7 is a flow chart of a treatment method of a composition for 3D printing material according to the present invention.

FIGS. 8A and 8B show the SEM result for normal recycled aggregates and PVA treated recycled aggregates, respectively.

### DETAILED DESCRIPTION OF THE INVENTION

One aspect of the present invention is the use of composition for 3D printing material and a treatment method of the composition. More particularly, it pertains to a composition using recycled aggregates and a surface treatment method of the recycled aggregates for 3D printing material.

The present invention proposes a formulation for 3D printing concrete utilizing recycled aggregates, comprising no less than 30% of recycled aggregates, in conjunction with an aggregate treatment method. Untreated recycled aggregates may result in higher water absorption, affecting printability such as buildability, extrudability and pumpability, resulting in reduced mechanical strength and high dry shrinkage. In addition, the low mechanical performance will result in potential damage during the transportation and service period, and the high dry shrinkage of 3D printed concrete may cause cracks during the hydration or low outdoor temperatures. In particular, when printing prototypes with spans over 1 meter, it has a high chance of deformation or larger cracks due to the relatively low flexural strength, therefore, it's necessary to include rebar to reinforce the structure, while this may cause more cracks due to the mismatched shrinkage leading to stress concentration between the 3D printed concrete and reinforcement.

To address these challenges, the present invention proposes a method for surface treating the recycled aggregates to improve the quality consistency and reduce aggregate water absorption, in addition, the aggregate size was also optimized. Therefore, the printability of the developed formulation incorporates 30% recycled aggregates enhanced. This formulation exhibits desirable properties such as improved mechanical performance, reduced shrinkage, lower water absorption and good fire resistance performance. Furthermore, based on the optimized formulation, NAMI has successfully printed and implemented various prototypes, such as planters (1.5 m in length) and long benches (2 m in length), which are currently under service.

Those of skill in the art will recognize that various combinations of the embodiments disclosed herein may be combined to provide a formulation for 3D printing concrete utilizing recycled aggregates, comprising over 30% of recycled aggregates, in conjunction with a treatment method. The present invention provides a composition for 3D printing material including a cementitious binder material, aggregates, water and an admixture material. Especially, the aggregates at least include recycled aggregates and silica sand, and the recycled aggregates are treated by a water-soluble polymer. The water-soluble polymer is polyvinyl alcohol (PVA) solution. For example, the weight percent concentration of the PVA solution is 5 wt-15 wt %.

Preferably, the water is in a total weight percentage of the composition from 10% to 20%. The cementitious binding material is in a total weight percentage of the composition from 20% to 40% and comprising 50% to 70% Portland cement. The recycled aggregates are in the total weight percentage from 10% to 30%, and the weight of the recycled aggregates is over 30% of the total aggregates. The silica sand is in the total weight percentage from 25% to 40%.

Large particle size of the recycled aggregate will be easy to collect and benefit for future commercialization. Preferably, the particle size of each of the recycled aggregates is from 0.3 mm to 2.36 mm. The particle size of each of the silica sand is from 0.3 mm to 0.6 mm.

In an embodiment, the cementitious binding material further includes fly ash, silica fume and/or GGBS (Ground Granulated Blast-furnace Slag). In an embodiment, the admixture material further includes superplasticizer, thixotropic agent, viscosity modifying agent, retarder and/or expansive additive.

Here are three examples of 3D printed concretes for comparison as shown in Table 1, and they are the same in preparation method and 3D printing process. The recycled aggregates (RA) are collected in K Wah Construction materials in HKSAR.

TABLE 1

| | | | | | Silica | | | | |
|---|---|---|---|---|---|---|---|---|---|
| Example | OPC | PFA | GGBS | Water | sand | RA | PVA | Gel208 | SP |
| 1 | 28.75% | 9.68% | 8.13% | 12.95% | 40.14% | 0 | 0 | 0.04% | 0.30% |
| 2 | 27.64% | 9.30% | 7.82% | 16.34% | 27.01% | 11.57% | 0 | 0.04% | 0.29% |
| 3 | 27.30% | 9.19% | 7.72% | 15.13% | 26.68% | 11.43% | 2.21% | 0.04% | 0.29% |

Example 1 is a reference without the recycled aggregates.

Example 2 includes 30% of the recycled aggregates, whose particle size is 0.3-2.36 mm.

Example 3 includes 30% of the treated recycled aggregates, whose particle size is 0.3-2.36 mm, with 10% PVA solution according to the present invention.

Here are descriptions of abbreviations in Table 1:
OPC is ordinary Portland cement (source from Green Island Cement).
PFA is pulverized fuel ash (source from Green Island Cement).
GGBS is ground granulated blast-furnace slag (source from Green Island Cement).
RA is the treated recycled aggregates (source from K. Wah Construction materials) according to the present invention.
Gel 208 is thixotropic agent (source from active minerals).
SP is superplasticizer (source from KFDN).

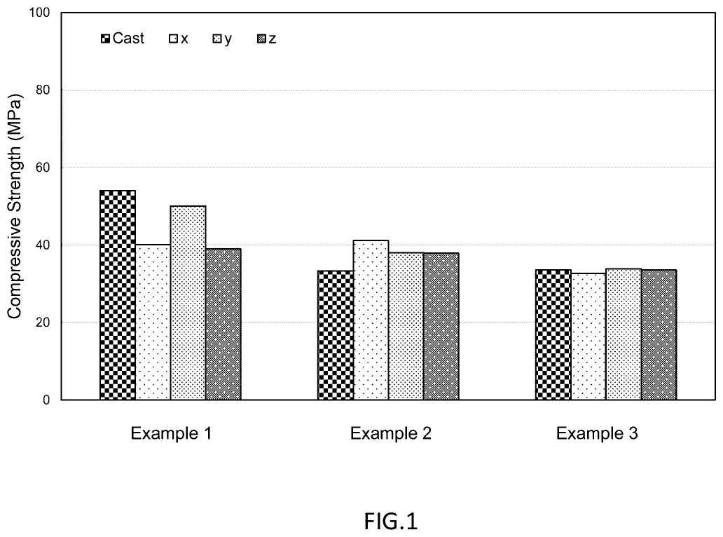

The results of compressive strength test of three 3D printed concretes are presented in the form of a bar diagram in FIG. 1, where four bars with different patterns in each example indicate three directions x, y and z, and their corresponding pouring specimens, respectively. Example 3 of 3D printed concrete according to the present invention has the best performance in the results of compressive strength test. Three directions x, y and z of the 3D printed concrete and its pouring specimen in Example 3 have the similar values.

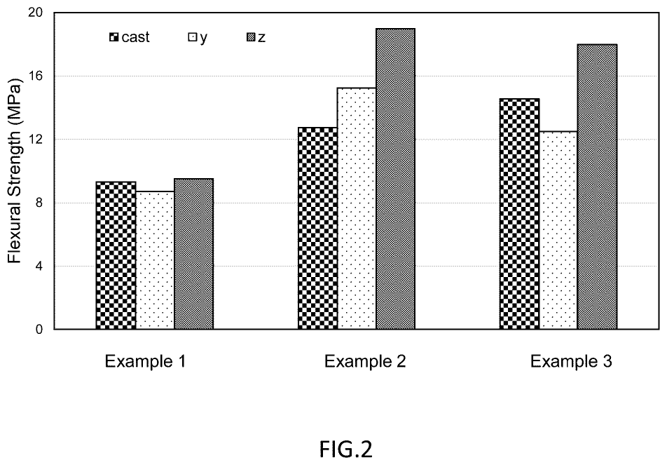

The results of flexural strength test of three 3D printed concretes are presented in the form of a bar diagram in FIG. 2, where three bars with different patterns in each example indicate two directions y and z, and their corresponding pouring specimens, respectively. Compared with Example 1 (without the recycled aggregates), Example 3 of 3D printed concrete shows enhancement in flexural strength which can be considered caused by the PVA treated aggregates which enhance the horizontal connection.

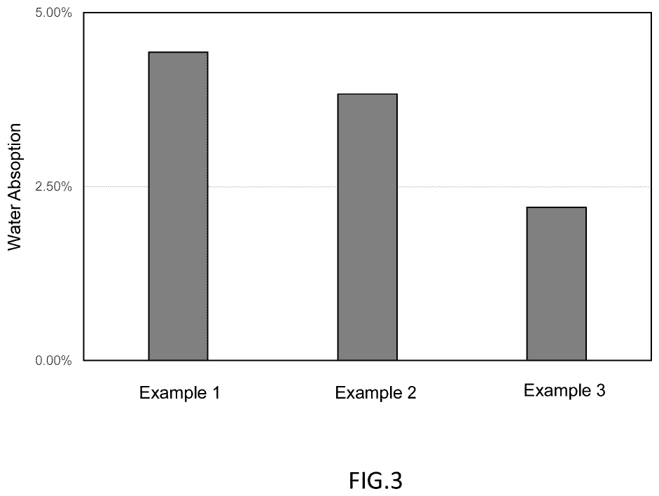

The results of water absorption test, which was followed ASTM C642, of three 3D printed concretes are presented in the form of a bar diagram in FIG. 3, where three bars indicate three examples, respectively. Example 3 of 3D printed concrete according to the present invention has the best performance in the results of water absorption test, too.

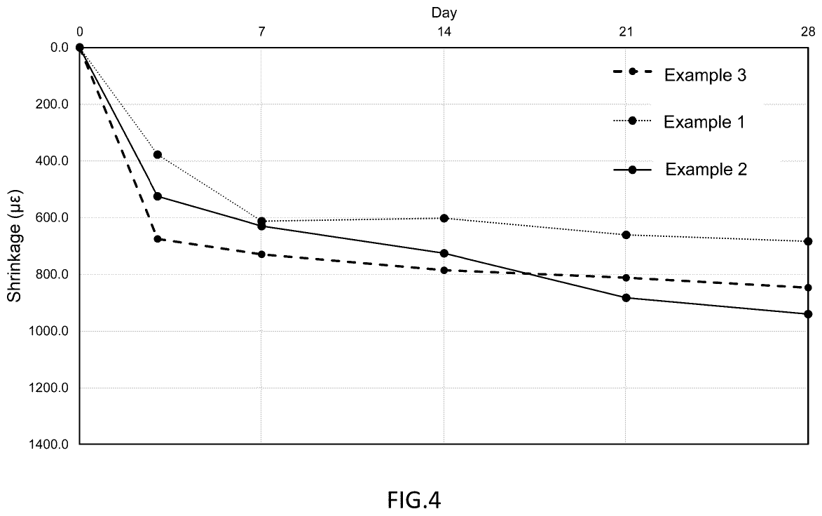

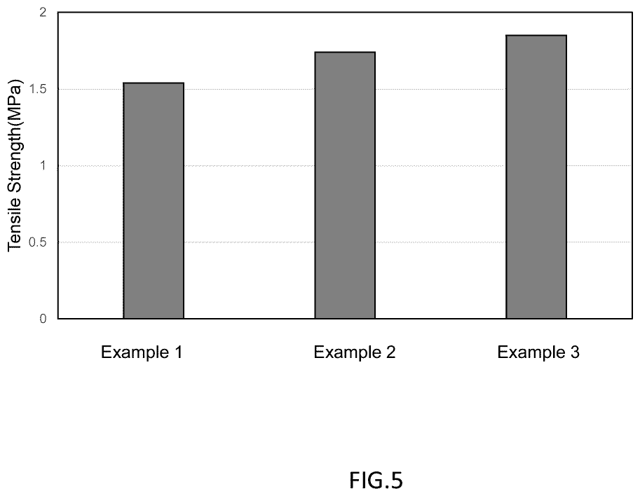

The results of shrinkage test of three 3D printed concretes are presented in the form of a line chart in FIG. 4, where three lines indicate three examples, respectively. Example 3 of 3D printed concrete according to the present invention presents the smoothest curves in the results of shrinkage test after 7 days. Furthermore, the results of tensile strength test after 28 days binding of three 3D printed concretes are presented in the form of a bar diagram in FIG. 5, where three bars indicate three examples, respectively. Example 3 of 3D printed concrete according to the present invention presents the best performance, too.

In a preferred embodiment, the expansive additive is low dosage expansive additive such as HPCSA (Denka powder CSA). In an embodiment, the aggregates further comprise nano silica or PP fiber.

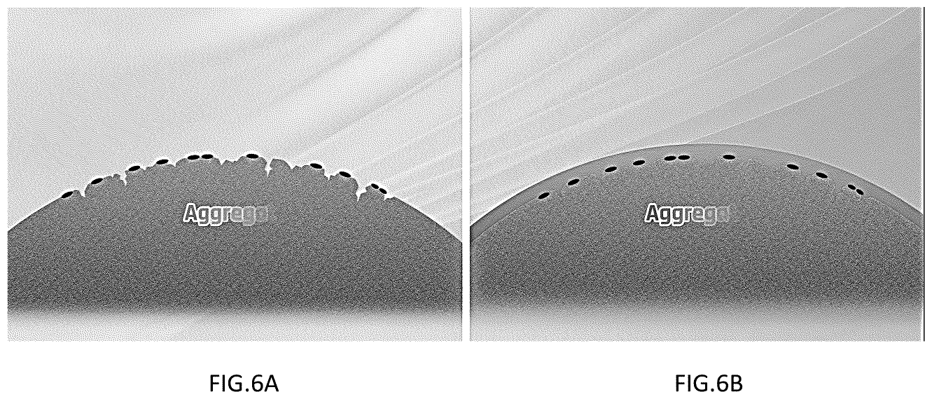

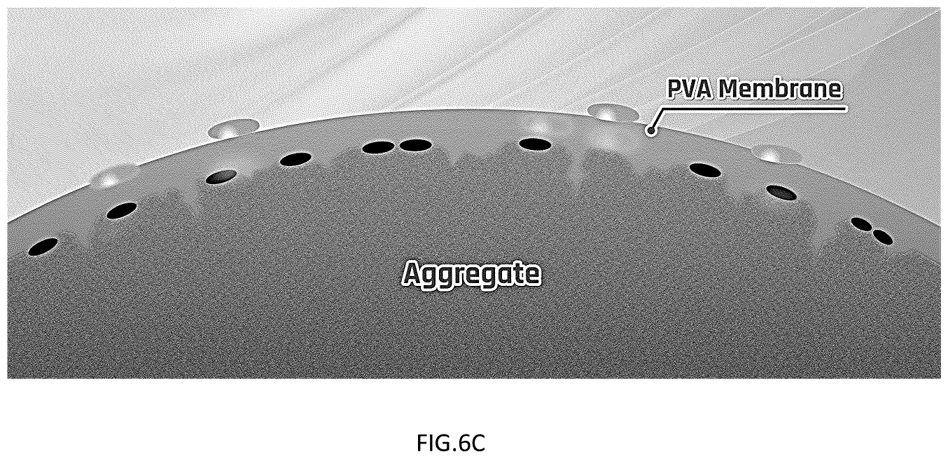

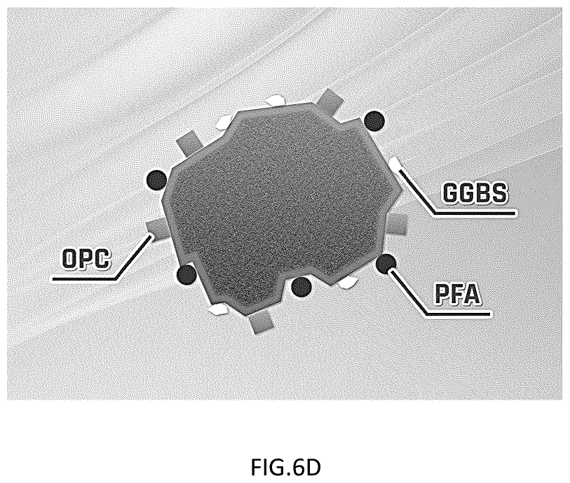

FIGS. 6A to 6D is a process of the treatment effect with PVA solution of a composition for 3D printing material according to the present invention. The treatment method of a composition for 3D printing material coats the recycled aggregate in the PVA membrane or film, so the composition for 3D printing material is enhanced the quality consistency. Moreover, the treated recycled aggregate coated with the ordinary Portland cement (OPC), the pulverized fuel ash (PFA) and the ground granulated blast-furnace slag (GGBS) in FIG. 6D can improve binding with cementitious materials.

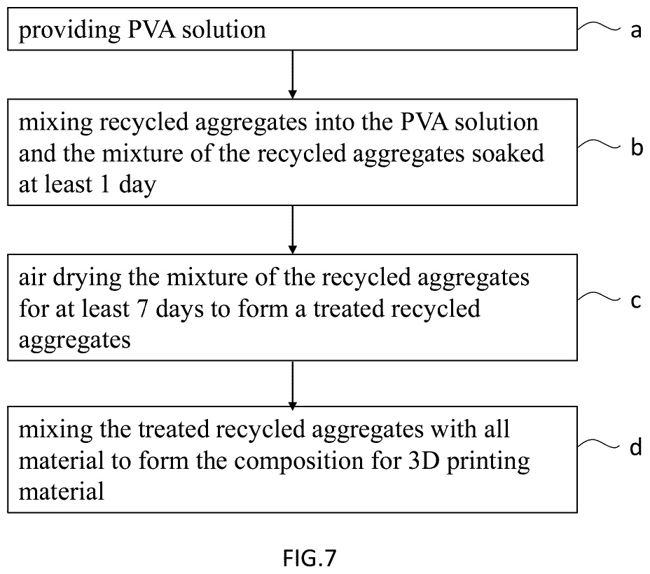

FIG. 7 is a flow chart of a treatment method of a composition for 3D printing material according to the present invention. The present invention provides a treatment method of a composition for 3D printing material, the steps of the method comprises: (a) providing 5 wt %-15 wt % polyvinyl alcohol (PVA) solution; (b) mixing recycled aggregates into the 5 wt %-15 wt % PVA solution and the mixture of the recycled aggregates soaked at least 24 hours; (c) air drying the mixture of the recycled aggregates for at least 7 days to form a treated recycled aggregates; and (d) mixing the treated recycled aggregates with a cementitious binder material, aggregates, water and an admixture material to form the composition for 3D printing material.

Preferably, the 5 wt %-15 wt % PVA solution is formed by PVA powder mixed with water in temperature from 90° C. to 100° C. The mixture of the recycled aggregates are air dried and spread in a 20° C. environment.

Preferably, the particle size of each of the recycled aggregates is from 0.3 mm to 2.36 mm. The weight of the recycled aggregates is over 30% of total of the aggregates and the recycled aggregates.

A treatment method of a composition for 3D printing material in one embodiment according to the present invention is listed. First, mix PVA powder with boiling water using an electric whisk until well blended. Then, add sieved recycled aggregates with particle sizes ranging from 0.3-2.36 mm. Mix again using the electric whisk to ensure thorough contact between the recycled aggregates and the PVA solution for approximately 10 to 15 minutes. Allow the mixture to settle overnight, then spread it out and let it air dry naturally in a 20° C. environment for 10 to 14 days. Finally, the treated recycled aggregates are prepared. Mix the treated recycled aggregates with a cementitious binder material, aggregates, water and an admixture material. The composition for 3D printing material according to the present invention is obtained.

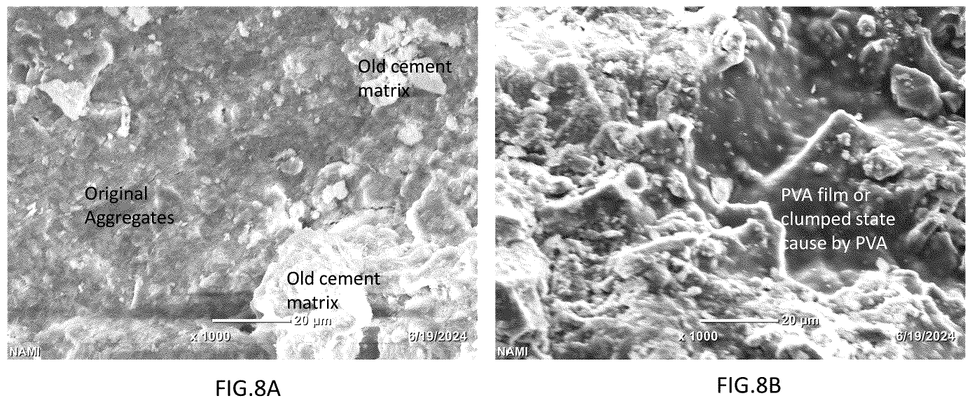

FIGS. 8A and 8B show the SEM result for normal recycled aggregates and PVA treated recycled aggregates, respectively. In treated recycled aggregates as shown in FIG. 8B, there is a noticeable PVA film or clumped state observed on the surface of the recycled aggregates. In contrast, untreated recycled aggregates in FIG. 8A show only some layered structures, which can be considered as old aggregates O and old cement matrix C.

The present invention provides advantages as follow:
1. An optimized composition for 3D printing material incorporates a minimum of 34% eco-materials (including both recycled materials and low-carbon materials) with excellent mechanical performance and durability properties.
2. A surface treatment method for recycled aggregates can replace up to 40% of normal aggregates while not affecting the mechanical performance. This innovation maintains quality consistency in 3D concrete materials, enhancing repeatability, printability, and buildability. In addition, the compressive strength and flexural strength could reach over 30 MPa and 10 MPa, respectively.
3. The dry shrinkage of 3D printed concrete is less than 900 με with the optimized particle size distribution and treatment method of recycled aggregates.
4. The formulation composition for 3D printing material has been verified in large-scale (over 1 cubic meter in design dimension) printing works and has been implemented on-site in various conditions (including low temperature, high or low humid conditions).

What is claimed is:

1. A composition for 3D printing material, said composition comprising a cementitious binder material, aggregates, water and an admixture material;
wherein the aggregates comprising recycled aggregates and silica sand, and the recycled aggregates are treated by a water-soluble polymer.

2. The composition of claim 1, wherein the water-soluble polymer is polyvinyl alcohol (PVA) solution.

3. The composition of claim 2, wherein the weight percent concentration of the PVA solution is from 5 wt % to 15 wt %.

4. The composition of claim 1, wherein the water is in a total weight percentage of the composition from 10% to 20%.

5. The composition of claim 4, wherein the cementitious binding material is in a total weight percentage of the composition from 20% to 40% and comprising 50% to 70% Portland cement.

6. The composition of claim 4, wherein the recycled aggregates are in the total weight percentage from 10% to 30%, and the weight of the recycled aggregates is over 30% of the total aggregates.

7. The composition of claim 4, wherein the silica sand is in the total weight percentage from 25% to 40%.

8. The composition of claim 1, wherein the particle size of each of the recycled aggregates is from 0.3 mm to 2.36 mm.

9. The composition of claim 1, wherein the particle size of each of the silica sand is from 0.3 mm to 0.6 mm.

10. The composition of claim 1, wherein the cementitious binding material further comprises fly ash, silica fume and/or GGBS (Ground Granulated Blast-furnace Slag).

11. The composition of claim 1, wherein the admixture material further comprises superplasticizer, thixotropic agent, viscosity modifying agent, retarder and expansive additive.

12. The composition of claim 11, wherein the expansive additive is low dosage expansive additive such as HPCSA (Denka powder CSA).

13. A treatment method of a composition for 3D printing material, comprising:
(a) providing 5 wt %-15 wt % polyvinyl alcohol (PVA) solution;
(b) mixing recycled aggregates into the 5 wt %-15 wt % PVA solution and the mixture of the recycled aggregates soaked at least 24 hours;
(c) air drying the mixture of the recycled aggregates for at least 7 days to form a treated recycled aggregates; and
(d) mixing the treated recycled aggregates with a cementitious binder material, aggregates, water and an admixture material to form the composition for 3D printing material.

14. The method of claim 13, wherein the 5 wt %-15 wt % PVA solution is formed by PVA powder mixed with water in temperature from 90° C. to 100° C.

15. The method of claim 13, wherein the mixture of the recycled aggregates are air dried in a 20° C. environment.

16. The method of claim 13, wherein the particle size of each of the recycled aggregates is from 0.3 mm to 2.36 mm.

17. The method of claim 13, wherein the weight of the recycled aggregates are over 30% of total of the aggregates and the recycled aggregates.
